(19) United States
(12) Patent Application Publication
(10) Pub. No.: US 2015/0091688 A1
(43) Pub. Date: Apr. 2, 2015

(54) COIL SHEET AND METHOD OF MANUFACTURING THE SAME

(71) Applicant: SAMSUNG ELECTRO-MECHANICS CO., LTD., Suwon (KR)

(72) Inventors: Chang Ryul JUNG, Suwon (KR); Kang Ryong CHOI, Suwon (KR); Sung Yong AN, Suwon (KR)

(73) Assignee: SAMSUNG ELECTRO-MECHANICS CO., LTD., Suwon (KR)

(21) Appl. No.: 14/106,349

(22) Filed: Dec. 13, 2013

(30) Foreign Application Priority Data
Sep. 27, 2013 (KR) 10-2013-0115637

(51) Int. Cl. H01F 27/28

(52) U.S. Cl. CPC H01F 27/2804; H01F 27/2852
USPC 336/200; 216/13

(57) ABSTRACT

There is provided a coil sheet including: a base sheet, and a coil unit disposed on the base sheet and including a central conductive part and a surface conductive part formed on surfaces of the central conductive part, wherein when a thickness of the surface conductive part formed on lateral surfaces of the central conductive part is ‘a’ and a thickness of the surface conductive part formed on an upper surface of the central conductive part is ‘b’, a<b may be satisfied.

### CROSS-REFERENCE TO RELATED APPLICATION

This application claims the benefit of Korean Patent Application No. 10-2013-0115637 filed on Sep. 27, 2013, with the Korean Intellectual Property Office, the disclosure of which is incorporated herein by reference.

### BACKGROUND

The present disclosure relates to a coil sheet on which a coil having high integration and low resistance is disposed, and a method of manufacturing the same.

As electronic devices have been reduced in size and thickness, flat coils used in electronic devices have been required to become smaller and thinner.

Efficiency of electronic devices using a magnetic field of a flat coil may be increased as strength of the magnetic field is increased and affected by a shape of the coil, an angle at which the coil is disposed in electronic devices, and the like.

B=μ₀×n×i [Equation 1]

In general, strength of a magnetic field is increased in proportion to magnetic permeability (μ₀), the number (n) of turns of a solenoid winding, and an amount (i) of flowing current.

In order to increase strength of a magnetic field over the same amount of magnetic permeability and current, the number (n) of turns of a solenoid winding needs to be increased.

Namely, in the case of a flat coil, in order to increase the strength of a magnetic field, the number of turns of a coil needs to be increased in an area of a limited flat surface to implement the miniaturization and thinning of the flat coil.

For the miniaturization and thinning of the flat coil, a flat coil needs to be highly integrated without non-utilized space (or a dead space). To this end, spaces between wound coil portions of a coil unit need to be easily controlled.

In addition thereto, in order to enhance efficiency of a flat coil, a cross-sectional area of a coil unit needs to be significantly increased within a limited space.

Thus, in order to enhance efficiency of electronic components employing a flat coil, demand for improvements of such flat coils is continuous.

### SUMMARY

An aspect of the present disclosure may provide a coil sheet on which a coil having high integration and low resistance is disposed and a method of manufacturing the same.

According to an aspect of the present disclosure, a coil sheet may include: a base sheet; and a coil unit disposed on the base sheet and including a central conductive part and a surface conductive part formed on surfaces of the central conductive part.

When a thickness of the surface conductive part formed on lateral surfaces of the central conductive part is ‘a’ and a thickness of the surface conductive part formed on an upper surface of the central conductive part is ‘b’, a<b may be satisfied.

The base sheet may include a magnetic material.

The coil unit may have two or more turns on the same plane.

When a width of a lower portion of the central conductive part is W1 and a width of a central portion of the central conductive part is W2, W2/W1≧0.85 may be satisfied.

A cross-sectional area of the surface conductive part may be greater than that of the central conductive part.

The central conductive part may include copper (Cu).

The surface conductive part may be a plated layer.

The surface conductive part may include copper (Cu).

According to another aspect of the present disclosure, a method of manufacturing a coil sheet may include: preparing abase sheet; forming a thin conductive layer on the base sheet; etching the thin conductive layer to form a central conductive part; and forming a surface conductive part on surfaces of the central conductive part through a plating process.

The plating process may be an anisotropic plating process.

The base sheet may include a magnetic material.

When a width of a lower portion of the central conductive part is W1 and a width of a central portion of the central conductive part is W2, the central conductive part may be formed to satisfy W2/W1≧0.85.

When a thickness of the surface conductive part formed on lateral surfaces of the central conductive part is ‘a’ and a thickness of the surface conductive part formed on an upper surface of the central conductive part is ‘b’, the central conductive part may be formed to satisfy a<b.

A cross-sectional area of the surface conductive part may be greater than that of the central conductive part.

The coil unit may have two or more turns on the same plane.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil sheet according to an exemplary embodiment of the present disclosure;

FIG. 2 is a cross-sectional view taken along line A-A′ of FIG. 1;

FIG. 3 is an enlarged view of region P of FIG. 2;

FIG. 4 is a flow chart illustrating a method of manufacturing a coil sheet according to another exemplary embodiment of the present disclosure; and

FIG. 5 is a process flow diagram illustrating a sequential process of the method of manufacturing a coil sheet according to another exemplary embodiment of the present disclosure.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Coil Sheet 100

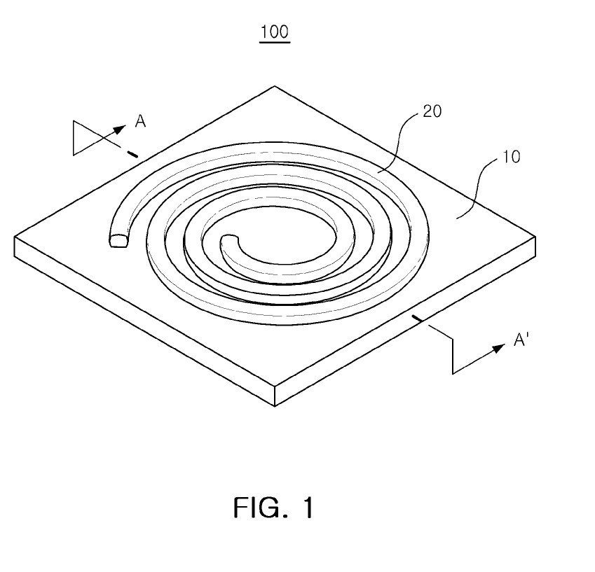

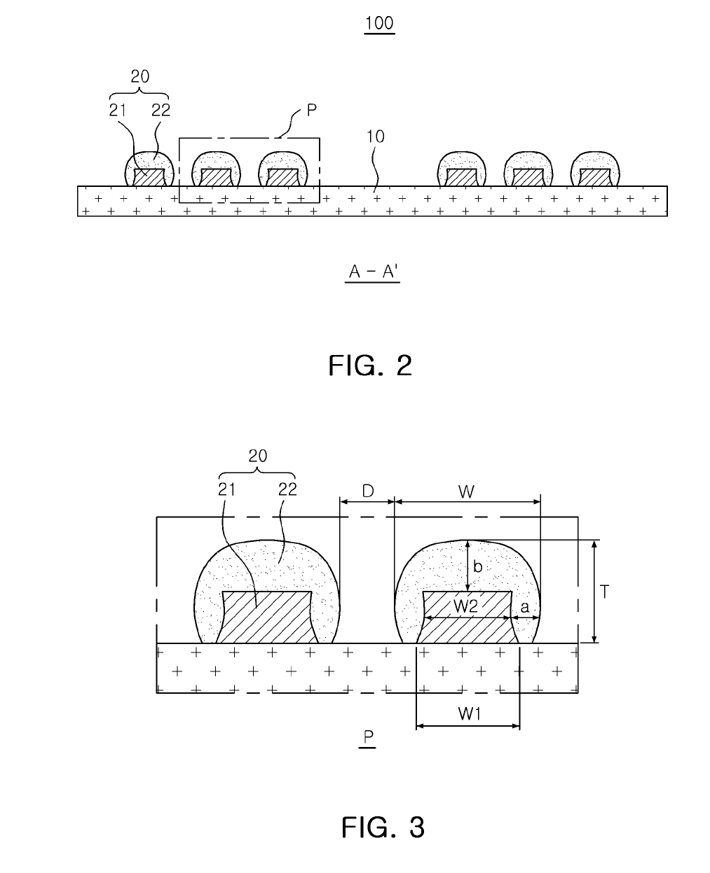

FIG. 1 is a perspective view schematically illustrating a coil sheet according to an exemplary embodiment of the present disclosure, and FIG. 2 is a cross-sectional view taken along line A-A′ of FIG. 1.

Referring to FIGS. 1 and 2, an exemplary embodiment of the present disclosure may provide a coil sheet 100 including a base sheet 10 and a coil unit 20.

The base sheet 10 may be a magnetic sheet including a magnetic material, and the magnetic sheet may include magnetic particles.

The magnetic particles may include one or more of metal powder particles, metal flakes, and ferrite particles.

The metal powder particles and metal flakes may include one or more selected from the group consisting of iron (Fe), an iron-silicon (Fe—Si) alloy, an iron-silicon aluminum (Fe—Si—Al) alloy, an iron-silicon-chromium (Fe—Si—Cr) alloy, and a nickel-iron-molybdenum (Ni—Fe—Mo) alloy, but the present inventive concept is not limited thereto.

The ferrite particles may include at least one of nickel-zinc-copper (Ni—Zn—Cu) and manganese-zinc (Mn—Zn), but the present inventive concept is not limited thereto.

The coil unit 20 is disposed on the base sheet 10. The coil unit 20 may be in direct contact with the base sheet 10, and may be disposed on and secured to the base sheet 10 by an adhesive.

The coil unit 20 may include a central conductive part 21 and a surface conductive part 22 covering surfaces of the central conductive part 21, and the surface conductive part may be a plated layer.

The central conductive part 21 and the surface conductive part 22 may include copper (Cu).

The coil unit 20 may have a spiral shape in which the coil unit 20 has two or more turns on the base sheet 10.

The central conductive part 21 may be formed by etching a thin conductive layer and may be formed in consideration of an intended final shape of the coil unit 20. This will be described in detail in a method of manufacturing a coil sheet to be described below.

The central conductive part 21 may be formed by etching a thin copper layer, but the present inventive concept is not limited thereto.

Shapes and dimensional relationships of the central conductive part 21 and the surface conductive part 22 will be described in detail with reference to FIG. 3 as an enlarged view illustrating region P of FIG. 2.

As illustrated in FIG. 3, the surface conductive part 22 may be formed on the surface of the central conductive part 21.

The surface conductive part 22 may be formed through a plating process.

The surface conductive part 22 may be formed through an isotropic plating process or may be formed through an anisotropic plating process.

In addition, the surface conductive part 22 may be formed to be thicker on an upper surface of the central conductive part 21 than on lateral surfaces of the central conductive part 21 through an anisotropic plating process.

In detail, when a thickness of the surface conductive part 22 formed on the lateral surfaces of the central conductive part 21 is ‘a’ and a thickness of the surface conductive part 22 formed on the upper surface of the central conductive part 21 is ‘b’, a<b may be satisfied.

In order to form the coil unit 20 having low resistance on the base sheet 10 having a limited area, the coil unit 20 may be formed to have a width and a thickness similar overall.

However, in the case in which a coil pattern having a thickness similar to a designed width is intended to be formed by etching a thin conductive layer, the coil pattern needs to be formed by etching a thin conductive layer having a thickness similar to the designed width, and here, since a thin conductive layer having a thickness relatively larger than that of a case in which a coil pattern having a relatively small thickness is formed, needs to be etched, the thin conductive layer is required to be etched to a deeper depth in a thickness direction.

However, in etching the thin conductive layer, etching is performed in a width direction as well as in the thickness direction. Thus, as the thickness of the thin conductive layer is increased, a space between patterns of the coil unit is increased during etching, resulting in a reduction in a degree of integration of the coil unit.

However, as in an exemplary embodiment of the present disclosure, when the central conductive part 21 is formed by etching a thin conductive layer and the surface conductive part 22 is formed through an anistropic plating process, a high degree of integration may be implemented, while increasing the thickness of the coil unit 20.

In detail, in an exemplary embodiment of the present disclosure, after the central conductive part is formed, the surface conductive part is formed to be thicker in the thickness direction than in the width direction through anisotropic plating, whereby the thickness of the coil unit 20 may be increased even in a case in which the thickness of the central conductive part is formed to be less than the designed width.

The central conductive part 21 may be formed by etching the thin conductive layer having a thickness smaller than that of a coil unit intended to be finally obtained, and in this case, in comparison to a case in which a thin conductive layer having a thickness identical to that of the coil unit intended to be finally obtained is etched, a depth of etching in the thickness direction may be reduced, and at the same time, a width of etching in the width direction is also reduced, increasing a degree of integration.

Thereafter, on the surfaces of the central conductive part 21, the surface conductive part 22 may be formed to be thicker in the thickness direction than in the width direction, thus increasing the thickness of the coil unit 20 to be finally formed.

Also, according to an exemplary embodiment of the present disclosure, in order to further enhance a degree of integration of the coil unit 20, a cross-sectional area of the surface conductive part 22 may be greater than that of the central conductive part 21.

Namely, in the case in which the surface conductive part 22 is formed to have a cross-sectional area greater than that of the central conductive part 21, the thickness of the central conductive part 21 may be reduced to remarkably increase a degree of integration of the coil unit 20.

In addition, as illustrated in FIG. 3, when a width of a lower portion of the central conductive part 21 is W1 and a width of a central portion of the central conductive part is W2, the central conductive part 21 may be formed to satisfy W2/W1 0.85.

If W2/W1 is less than 0.85, electrons may not flow smoothly, increasing resistance in the coil unit, and an effective area of the coil unit may be increased, leading to difficulties in reducing a size of a product.

Thus, according to an exemplary embodiment of the present disclosure, the coil sheet including the coil unit having a high degree of integration and a low level of resistance may be provided.

In detail, when a width of the coil unit 20 is W, a thickness thereof is T, and a space between wound coil portions of the coil unit 20 is D, the coil sheet 100 may be formed to satisfy T/W≧0.01 and D/T≦0.1.

Method of Manufacturing Coil Sheet

In describing a method of manufacturing a coil sheet, repeated descriptions of the structure and effects of the coil sheet 100 described above will be omitted and differences will mainly be described.

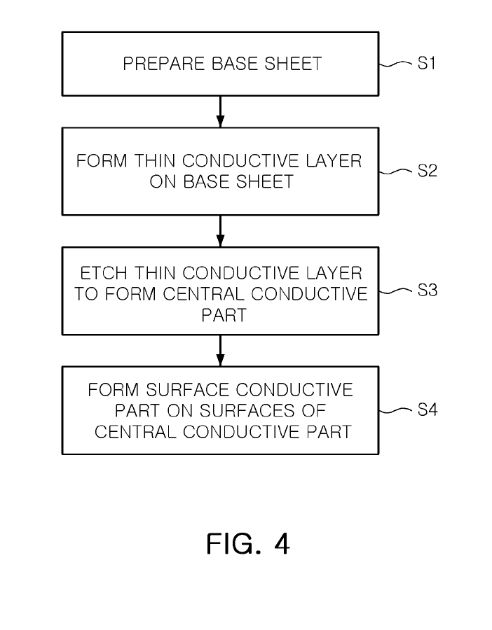

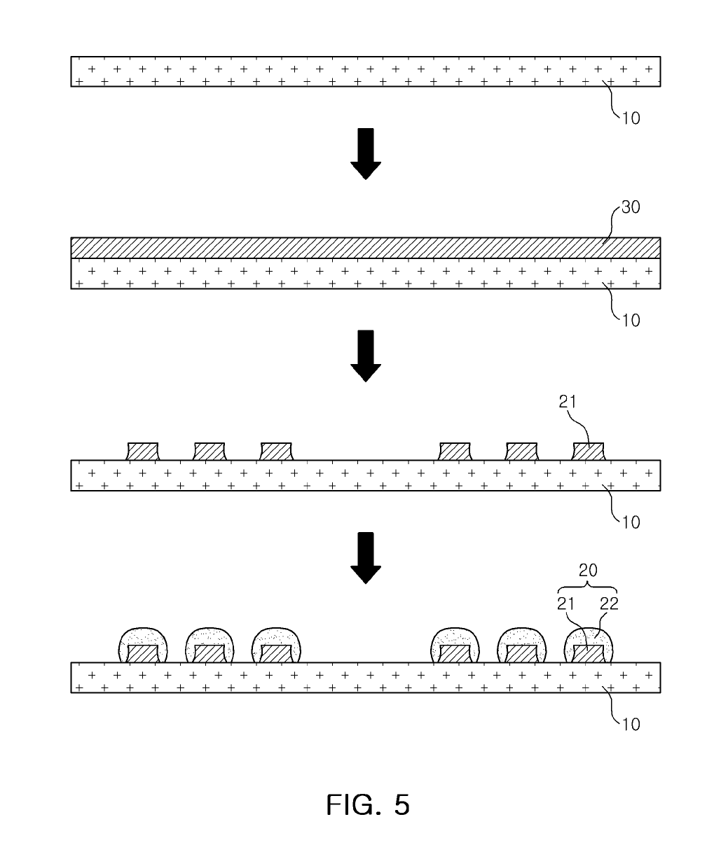

FIG. 4 is a flow chart illustrating a method of manufacturing a coil sheet according to another exemplary embodiment of the present disclosure, and FIG. 5 is a process flow diagram illustrating a sequential process of the method of manufacturing a coil sheet according to another exemplary embodiment of the present disclosure.

Referring to FIGS. 4 and 5, a method of manufacturing a coil sheet according to another exemplary embodiment of the present disclosure may include preparing the base sheet 10 (S1); forming a thin conductive layer 30 on the base sheet 10 (S2); etching the thin conductive layer 30 to form the central conductive part 21 (S3); and forming the surface conductive part 22 on surfaces of the central conductive part 21 through an anisotropic plating process (S4).

The base sheet 10 may be a magnetic sheet including a magnetic material, and the magnetic sheet may include magnetic particles.

The thin conductive layer 30 may be formed to be in direct contact with the base sheet 10, and alternatively, a protective layer or an adhesive layer may be formed on the base sheet 10 and the thin conductive layer 30 may be subsequently formed on the protective layer or the adhesive layer.

Thereafter, the thin conductive layer 30 may be etched to form the central conductive part 21. The central conductive part may be formed to have a spiral shape in which the central conductive part has two or more turns in consideration of a shape of the coil unit 20 to be finally formed.

When the width of the lower portion of the central conductive part 21 is W1 and the width of the central portion of the central conductive part 21 is W2, the central conductive part 21 may be formed to satisfy W2/W1≧0.85.

Thereafter, the surface conductive part 22 may be formed on the surfaces of the central conductive part 21 through plating.

When the surface conductive part 22 is formed through anisotropic plating, the surface conductive part 22 may be formed to be thicker on the upper surface of the central conductive part 21 than on the lateral surfaces of the central conductive part 21.

In the case of anisotropic plating, plating may be performed by varying a plating speed depending on a direction. Through anisotropic plating, a thickness of the surface conductive part 22 may differ depending on a direction, which may be implemented by adjusting the concentration of a plating solution.

In detail, in an exemplary embodiment of the present disclosure, a plating solution having high concentration is applied to the upper surface of the central conductive part 21, while a plating solution having low concentration is applied to the lateral surface of the central conductive part 21. In this case, a considerable amount of plating may be performed on the upper surface of the central conductive part 21, such that the surface conductive part 22 formed on the upper surface of the central conductive part 21 may be thicker than the surface conductive part 22 formed on the lateral surfaces of the central conductive part 21.

When the thickness of the surface conductive part 22 formed on the lateral surfaces of the central conductive part 21 is ‘a’ and the thickness of the surface conductive part 22 formed on the upper surface of the central conductive part 21 is ‘b’ through anisotropic plating, a<b may be satisfied.

In addition, in order to further enhance a degree of integration of the coil unit 20, a cross-sectional area of the surface conductive part 22 may be greater than that of the central conductive part 21.

Also, unlike the foregoing method, the coil unit 20 of the coil sheet 100 may be formed on an auxiliary sheet such as a polyamide substrate and transferred to be disposed on the base sheet 10, rather than being directly formed on the base sheet 10.

In this case, the coil unit 20 may be coupled to the base sheet 10 by an adhesive member.

As set forth above, according to exemplary embodiments of the present disclosure, the coil sheet including a coil having a high degree of integration and a low level of resistance and the method of manufacturing the same may be provided.

While exemplary embodiments have been shown and described above, it will be apparent to those skilled in the art that modifications and variations could be made without departing from the spirit and scope of the present disclosure as defined by the appended claims.

What is claimed is:

1. A coil sheet comprising:
a base sheet; and
a coil unit disposed on the base sheet and including a central conductive part and a surface conductive part formed on surfaces of the central conductive part.

2. The coil sheet of claim 1, wherein when a thickness of the surface conductive part formed on lateral surfaces of the central conductive part is ‘a’ and a thickness of the surface conductive part formed on an upper surface of the central conductive part is ‘b’, a<b is satisfied.

3. The coil sheet of claim 1, wherein the base sheet includes a magnetic material.

4. The coil sheet of claim 1, wherein the coil unit has two or more turns on the same plane.

5. The coil sheet of claim 1, wherein when a width of a lower portion of the central conductive part is W1 and a width of a central portion of the central conductive part is W2, W2/W1≧0.85 is satisfied.

6. The coil sheet of claim 1, wherein a cross-sectional area of the surface conductive part is greater than that of the central conductive part.

7. The coil sheet of claim 1, wherein the central conductive part includes copper (Cu).

8. The coil sheet of claim 1, wherein the surface conductive part is a plated layer.

9. The coil sheet of claim 1, wherein the surface conductive part includes copper (Cu).

10. A method of manufacturing a coil sheet, the method comprising:
preparing a base sheet;
forming a thin conductive layer on the base sheet;
etching the thin conductive layer to form a central conductive part; and
forming a surface conductive part on surfaces of the central conductive part through a plating process.

11. The method of claim 10, wherein the plating process is an anisotropic plating process.

12. The method of claim 10, wherein the base sheet includes a magnetic material.

13. The method of claim 10, wherein when a width of a lower portion of the central conductive part is W1 and a width of a central portion of the central conductive part is W2, the central conductive part is formed to satisfy W2/W1≧0.85.

14. The method of claim 10, wherein when a thickness of the surface conductive part formed on lateral surfaces of the central conductive part is ‘a’ and a thickness of the surface conductive part formed on an upper surface of the central conductive part is ‘b’, the central conductive part is formed to satisfy a<b.

15. The method of claim 10, wherein a cross-sectional area of the surface conductive part is greater than that of the central conductive part.

16. The method of claim 10, wherein the coil unit has two or more turns on the same plane.
